(19) United States
(12) Patent Application Publication
(10) Pub. No.: US 2020/0235630 A1
(43) Pub. Date: Jul. 23, 2020

(54) CIRCUIT BOARD ASSEMBLY AND ELECTRIC OIL PUMP PROVIDED WITH SAME

(71) Applicant: Nidec Tosok Corporation, Zama-shi, Kanagawa (JP)

(72) Inventors: Yoshiyuki KOBAYASHI, Zama-shi (JP); Shigehiro KATAOKA, Zama-shi (JP)

(21) Appl. No.: 16/639,136

(22) PCT Filed: Aug. 16, 2018
(86) PCT No.: PCT/JP2018/030417

§ 371 Date: Feb. 14, 2020

(30) Foreign Application Priority Data
Aug. 31, 2017 (JP) 2017-167986

(51) Int. Cl. H02K 5/22; H02K 7/14; H02K 11/33; H02K 21/16; H01R 12/71; H01R 13/42; F04D 13/06; F04D 29/18; F04D 29/043; F04D 29/40

(52) U.S. Cl. CPC H02K 5/225; H02K 7/14; H02K 11/33; H02K 21/16; H01R 12/71; H02K 2211/03; F04D 13/06; F04D 29/18; F04D 29/043; F04D 29/406; H01R 13/42

(57) ABSTRACT

A circuit board assembly includes a circuit board, an inverter housing including a circuit board accommodating portion, and an external terminal connected to the circuit board. The circuit board includes a connection hole, and the inverter housing includes an external terminal receiving portion projecting on a bottom surface of the circuit board accommodating portion. The external terminal receiving portion includes an external terminal fitting hole including an insertion side opening that opens on a bottom of the inverter housing, and a projection side opening that opens on a tip of the external terminal receiving portion. The projection side opening faces the connection hole, and the external terminal is disposed in the external terminal fitting hole so as to project from the projection side opening and be inserted into the connection hole.

### CROSS REFERENCE TO RELATED APPLICATIONS

This is a U.S. national stage of PCT Application No. PCT/JP2018/030417, filed on Aug. 16, 2018, and priority under 35 U.S.C. § 119(a) and 35 U.S.C. § 365(b) is claimed from Japanese Application No. 2017-167986, filed Aug. 31, 2017; the entire disclosures of each application being hereby incorporated herein by reference.

### 1. FIELD OF THE INVENTION

The present disclosure relates to a circuit board assembly and an electric oil pump including the same.

### 2. BACKGROUND

For example, Japanese Unexamined Patent Publication No. 2013-092126 discloses an electric oil pump in which an inverter part having a circuit board and an electric pump are integrated. This electric oil pump has an oil pump part and the inverter part. The inverter part has a resin inverter case, a control board accommodated in the inverter case, and a metal cover which is fixed to the inverter case and covers the control board.

An inverter circuit which supplies a controlled current to a winding wound around a stator of a motor unit is mounted on the control board. A connector terminal is attached between the inverter case and the cover and supplies control signals and electric power to an electric element mounted on the control board.

In the inverter part disclosed in Japanese Unexamined Patent Publication No. 2013-092126, a connector part for inserting an external terminal is provided to protrude from an end part of the inverter case extending radially outward from the motor unit. The connector terminal electrically connected to the control board is provided inside the connector part. For this reason, the inverter part is enlarged due to the connector part which protrudes from the inverter case.

Also, in the case in which an electric oil pump is fixed to a transmission, the electric oil pump is installed in an existing space of a vehicle, therefore there are severe restrictions on mounting, and miniaturization is required to enable it to be installed in various mounting spaces. In particular, when the electric oil pump is provided with an inverter unit, further miniaturization is required.

### SUMMARY

Example embodiments of the present disclosure provide circuit board assemblies in each of which an inverter is able to be miniaturized with an external terminal connected to a control board, and also provide electric oil pumps including such circuit board assemblies.

A circuit board assembly according to an example embodiment of the present disclosure includes a circuit board, an inverter housing including a bottomed container-shaped circuit board accommodating portion that accommodates the circuit board, and an external terminal in the circuit board accommodating portion, connected to an end on one side in a width direction of the circuit board, and extends to a bottom surface of the circuit board accommodating portion, wherein the circuit board includes a connection hole into which the external terminal is inserted, the connection hole penetrates the circuit board in a thickness direction thereof, the inverter housing includes an external terminal receiving portion protruding from the bottom surface of the circuit board accommodating portion toward the connection hole side of the circuit board, the external terminal receiving portion includes an external terminal fitting hole penetrating between an end of the external terminal receiving portion on the circuit board side and a bottom of the inverter housing, the external terminal fitting hole includes an insertion side opening that opens at the bottom of the inverter housing, and a projection side opening that opens at the circuit board side end of the external terminal receiving portion, the projection side opening faces the connection hole of the circuit board, the external terminal is inserted into the external terminal fitting hole from the insertion side opening and is disposed in the external terminal fitting hole in a state in which a tip of the external terminal protrudes from the projection side opening and is inserted into the connection hole.

According to an example embodiment of the present disclosure, it is possible to provide a circuit board assembly in which enlargement of an inverter is able to be prevented with an external terminal connected to a control board, and an electric oil pump including the same.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view of an electric oil pump according to a first example embodiment of the present disclosure.

FIG. 2 is a cross-sectional view of an inverter housing according to the first example embodiment of the present disclosure.

FIG. 3 is a plan view of the inverter housing according to the first example embodiment of the present disclosure when viewed from a side behind thereof.

FIG. 4 is a partial cross-sectional view of a circuit board assembly according to the first example embodiment of the present disclosure.

FIG. 5 is a perspective view of the inverter housing having an external terminal receiving part according to the first example embodiment of the present disclosure.

FIG. 6 is a plan view of the external terminal receiving part according to the first example embodiment of the present disclosure.

### DETAILED DESCRIPTION

Hereinafter, circuit board assemblies and electric oil pumps according to example embodiments of the present disclosure will be described with reference to the drawings. Since the circuit board assembly is provided in the electric oil pump, the circuit board assembly will be described in the description of the electric oil pump. Also, in the following drawings, in order for easy understanding of each constituent, scales, numbers and the like in each structure may be different from those in actual structures.

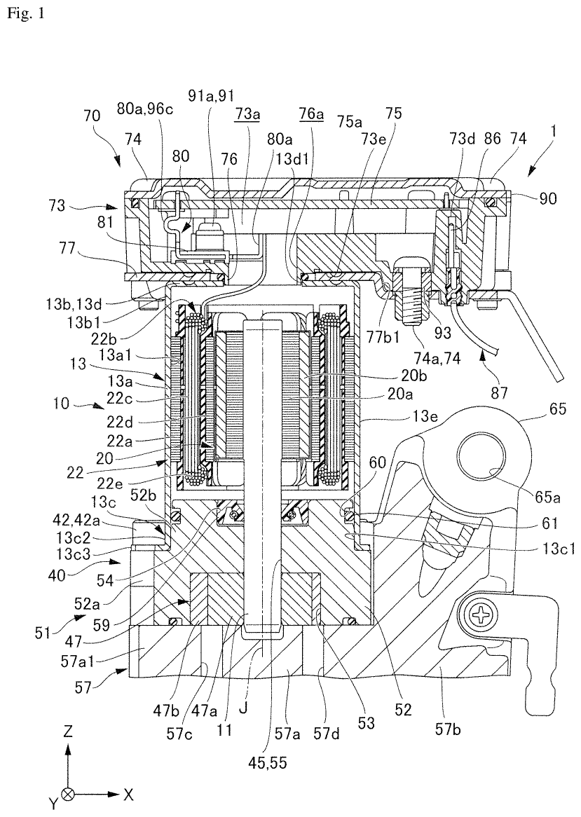

Also, in the drawings, an XYZ coordinate system is appropriately shown as a three-dimensional orthogonal coordinate system. In the XYZ coordinate system, a Z-axis direction is a direction parallel to an axial direction of a central axis J shown in FIG. 1. An X-axis direction is a direction parallel to a short length direction of the electric oil pump shown in FIG. 1, that is, a lateral direction in FIG. 1. A Y-axis direction is a direction orthogonal to both the X-axis direction and the Z-axis direction.

Also, in the following description, a positive side (+Z side) in the Z-axis direction is referred to as a “rear side”, and a negative side (−Z side) in the Z-axis direction is referred to as a “front side.” Further, the rear side and the front side are simply names used for explanation and do not limit actual positional relationships and directions. In addition, unless otherwise specified, a direction parallel to the central axis J (Z-axis direction) is simply referred to as an “axial direction,” a radial direction centered on the central axis J is simply referred to as a “radial direction,” and a circumferential direction centered on the central axis J, that is, a direction around the central axis J (θ direction), is simply referred to as a “circumferential direction.”

Moreover, in the present specification, “extending in the axial direction” includes not only strictly extending in the axial direction (Z-axis direction) but also extending in a direction inclined less than 45 degrees with respect to the axial direction. Also, in the present specification, “extending in the radial direction” includes not only strictly extending in the radial direction, that is, a direction perpendicular to the axial direction (Z-axis direction) but also extending in a direction inclined less than 45 degrees with respect to the radial direction.

### First Example Embodiment

### <Overall Configuration>

FIG. 1 is a cross-sectional view of an electric oil pump according to a first example embodiment. As shown in FIG. 1, the electric oil pump 1 of the present example embodiment includes a motor unit 10, a pump unit 40, and a circuit board assembly 70. The motor unit 10 and the pump unit 40 are disposed along the axial direction. The motor unit 10 includes a shaft 11 disposed along a central axis J extending in the axial direction. The pump unit is positioned on one side (the front side) in the axial direction on the motor unit 10 and is driven by the motor unit 10 via the shaft 11 to discharge oil. The circuit board assembly 70 is positioned on the other side (the rear side) in the axial direction on the motor unit 10 and is fixed to the motor unit 10 via a base plate 77. Hereinafter, each constituent member will be described in detail.

### <Motor Unit 10>

As shown in FIG. 1, the motor unit 10 includes a motor housing 13, a rotor 20, the shaft 11, and a stator 22.

The motor unit 10 is, for example, an inner rotor type motor, in which the rotor 20 is fixed to an outer circumferential surface of the shaft 11 and the stator 22 is positioned outward in the radial direction from the rotor 20.

### (Motor Housing 13)

The motor housing 13 has a stator holding part 13a, an inverter holding part 13b, and a pump body holding part 13c. The motor housing 13 is made of a metal. The motor housing 13 has a bottomed cylindrical shape having a bottom part 13d on the circuit board assembly 70 side.

### (Stator Holding Part 13a)

The stator holding part 13a extends in the axial direction and has a through hole 13a1 therein. The shaft 11, the rotor 20, and the stator 22 of the motor unit 10 are disposed in the through hole 13a1. An outer surface of the stator 22, that is, an outer surface of a core back part 22a, which will be described later, is fitted to an inner surface of the stator holding part 13a. Thus, the stator 22 is accommodated in the stator holding part 13a.

### (Inverter Holding Part 13b)

The inverter holding part 13b is a part connected to a rear end part 13b1 of the stator holding part 13a. In the present example embodiment, the inverter holding part 13b includes the rear end part 13b1 of the stator holding part 13a and a disk-shaped bottom part 13d extending radially inward from the rear end part 13b1. A motor unit side through hole 13d1 penetrating in the axial direction is provided at a central part of the bottom part 13d. A coil end insertion part 76 provided to protrude from the front side of the bottom part of the circuit assembly 70 is inserted into the motor unit side through hole 13d1. An inverter part side through hole 76a penetrating in the axial direction is provided in the coil end insertion part 76. The inverter part side through hole 76a provides communication between an inside of the motor unit 10 and an inside of the circuit board assembly 70. Details of the coil end insertion part 76 will be described later.

The base plate 77 provided at the front side end part of the circuit board assembly 70 is placed on the bottom part 13d of the motor housing 13, and the base plate 77 is welded to the bottom part 13d. For this reason, the circuit board assembly 70 is fixed to the bottom part 13d of the motor housing 13.

### (Pump Body Holding Part 13c)

The pump body holding part 13c has a cylindrical shape in which the front side thereof opens and is continuously connected to a front side end of the stator holding part 13a. The pump body holding part 13c has a hole part 13c1 extending in the axial direction. An inner diameter of the hole part 13c1 has a dimension slightly larger than that of the rear side outer diameter of the pump body 52 of the pump unit 40, which will be described later. The rear side of the pump body 52 is fitted to an inner surface of the hole part 13c1.

An outer surface 13c2 of the pump body holding part 13c has motor side flange parts 13c3 protruding in the radial direction. The motor side flange parts 13c3 are disposed to face pump side flange parts 52a provided in the pump body 52, which will be described later, and are fixed to the pump side flange parts 52a using fixing members 42 such as bolts 42a. Thus, the pump unit 40 is fixed to the motor housing 13.

### (Rotor 20)

The rotor 20 has a rotor core 20a and rotor magnets 20b. The rotor core 20a is fixed to the shaft 11 to surround the shaft 11 around the axis (θ direction). The rotor magnets 20b are fixed to an outer surface of the rotor core 20a around the axis (θ direction). The rotor core 20a and the rotor magnets 20b rotate together with the shaft 11. Also, the rotor 20 may be an embedded magnet type in which permanent magnets are embedded in the rotor 20. As compared with a surface magnet type in which permanent magnets are provided on a surface of the rotor 20, the embedded magnet type rotor 20 can reduce a likelihood that the magnets will come off due to a centrifugal force, and can actively use reluctance torque.

### (Stator 22)

The stator 22 surrounds the rotor 20 around the axis (θ direction) and rotates the rotor 20 around the central axis J. The stator 22 includes a core back part 22a, teeth parts 22c, a coil 22b, and an insulator (bobbin) 22d.

A shape of the core back part 22a is a cylindrical shape concentric with the shaft 11. The teeth parts 22c extend toward the shaft 11 from an inner surface of the core back part 22a. A plurality of teeth parts 22c are provided and are disposed at equal intervals in the circumferential direction of the inner surface of the core back part 22a. The coil 22b is provided around the insulator (bobbin) 22d and is formed by winding a conductive wire 22e. The insulator (bobbin) 19 is attached to each tooth part 22c.

### (Shaft 11)

As shown in FIG. 1, the shaft 11 extends along the central axis J and penetrates the motor unit 10. The front side (−Z side) of the shaft 11 protrudes from the motor unit 10 and extends into the pump unit 40. The rear side (+Z side) of the shaft 11 protrudes from the rotor 20 and becomes a free end. For this reason, the rotor 20 is in a cantilevered state in which the front side of the shaft 11 is supported by a sliding bearing 45, which will be described later.

### (Circuit Board Assembly 70)

The circuit board assembly 70 includes an inverter housing 73 and a cover part 90.

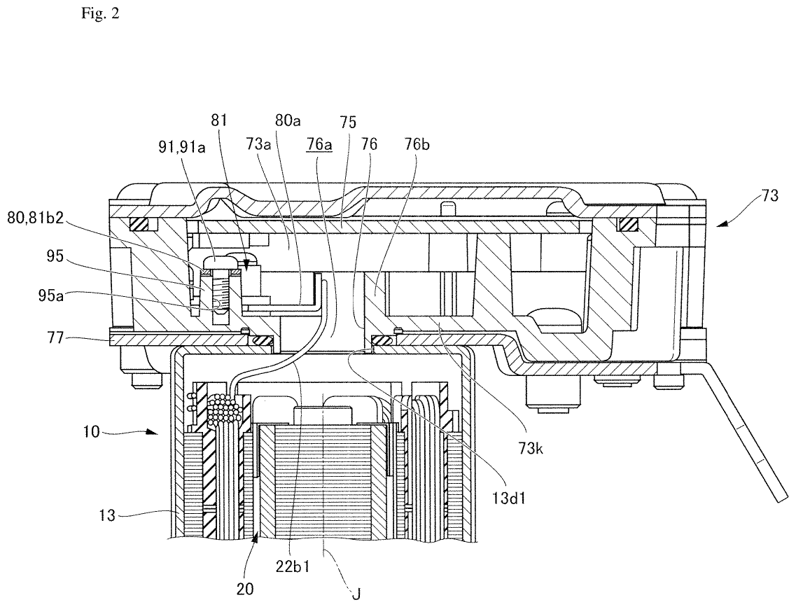

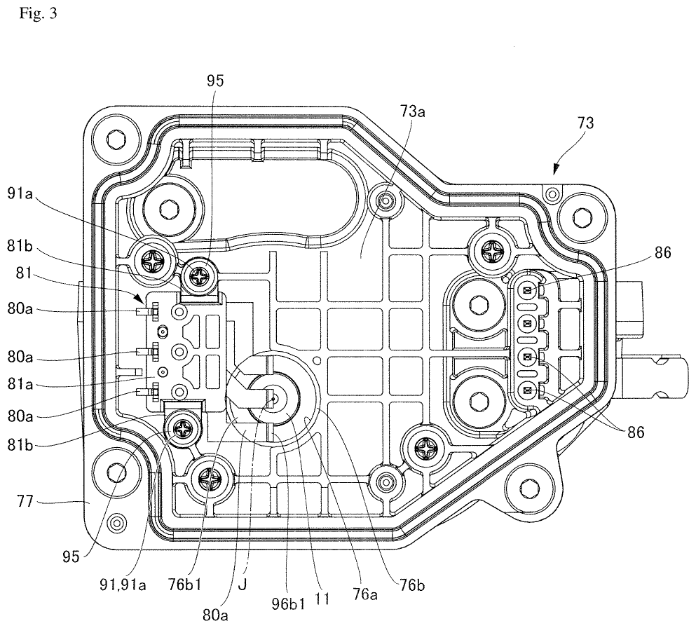

FIG. 2 is a cross-sectional view of the inverter housing 73 according to the first example embodiment. FIG. 3 is a plan view of the inverter housing 73 according to the first example embodiment when viewed from a side behind thereof. The inverter housing 73 is an integrally molded product made of a resin. As shown in FIGS. 2 and 3, the inverter housing 73 has a bottomed container shape that has a circuit board accommodating part 73a of which the rear side opens and is recessed to the front side, and extends in the X-axis and Y-axis directions. The inverter part side through hole 76a extending coaxially with the central axis J is provided in a front side end wall part 73k of the circuit board accommodating part 73a of the inverter housing 73. This inverter part side through hole 76a is provided inside a cylindrical wall part 76b extending from the end wall part 73k to both sides in the axial direction. The front side of the wall part 76b protrudes further to the front side than the end wall part 73k and extends into the motor unit side through hole 13d1 provided in the bottom part 13d of the motor housing 13.

On the other hand, the rear side of the wall part 76b extends rearward from the end wall part 73k and extends to a position that is approximately half a depth of the circuit board accommodating part 73a in the axial direction. In addition, a cutout part 76b1 into which a bus bar terminal 80a of a bus bar 80 can be inserted is provided in the wall part 76b on a side of the rear side of the wall part 76b on which a bus bar holder 81 is disposed. A coil end 22b1 extending from the motor unit 10 is connected to the bus bar terminal 80a through the inverter part side through hole 76a. For this reason, since the coil end 22b1 passes through the resin wall part 76b, insulation of the coil end 22b1 can be maintained.

The bus bar holder 81 and the bus bar 80 are integrally molded products made of a resin. As shown in FIG. 3, the bus bar holder 81 is disposed in the circuit board accommodating part 73a on a side opposite to an external terminal 86 side, which is electrically connected to a circuit board 75, with respect to the shaft 11 of the motor unit 10. In the present example embodiment, the bus bar holder 81 is disposed leftward in the X-axis direction from the inverter part side through hole 76a. The bus bar holder 81 has a recess-shaped holder body part 81a recessed from the rear side to the front side, and a fixing part 81b protruding further outward than a width between both ends of the holder body part 81a from one end side end part of the holder body part 81a. The holder body part 81a is disposed in the circuit board accommodating part 73a with a recess-shaped end part 81d thereof on a side recessed in a recess shape facing the motor unit 10 side.

As shown in FIGS. 2 and 3, protruding parts 95 which protrude to the rear side are provided at a bottom part of the circuit board accommodating part 73a. In the present example embodiment, the protruding parts 95 are provided at two places on a left side in the X-axis direction with respect to the inverter part side through hole 76a and on one side and the other side in the Y-axis direction with respect to the central axis J. The two protruding parts 95 are disposed to deviate to a plus side in the Y axis direction with respect to the central axis J. The parts of the rear side of the protruding parts 95 are positioned at a height that is approximately half a height of the circuit board accommodating part 73a in the axial direction. Female thread parts 95a that open to the tip parts and extend to the front side are provided in the protruding parts 95. Fixing members 91 such as bolts 91a are screwed into the female thread parts 95a to fasten flange parts 81b2.

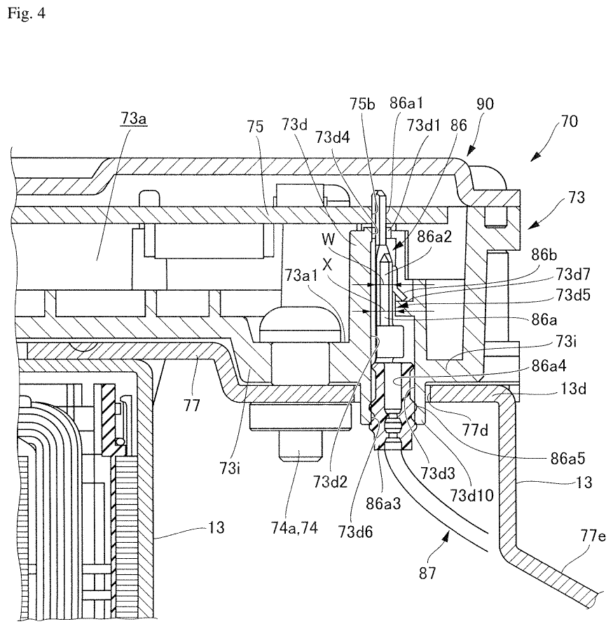

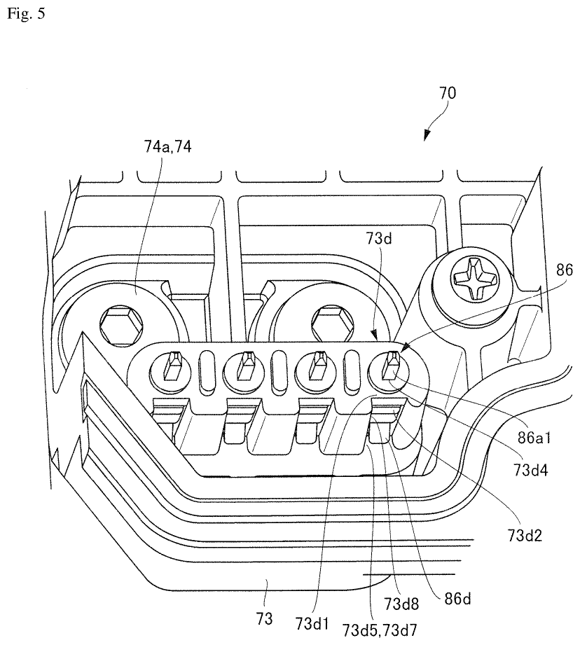

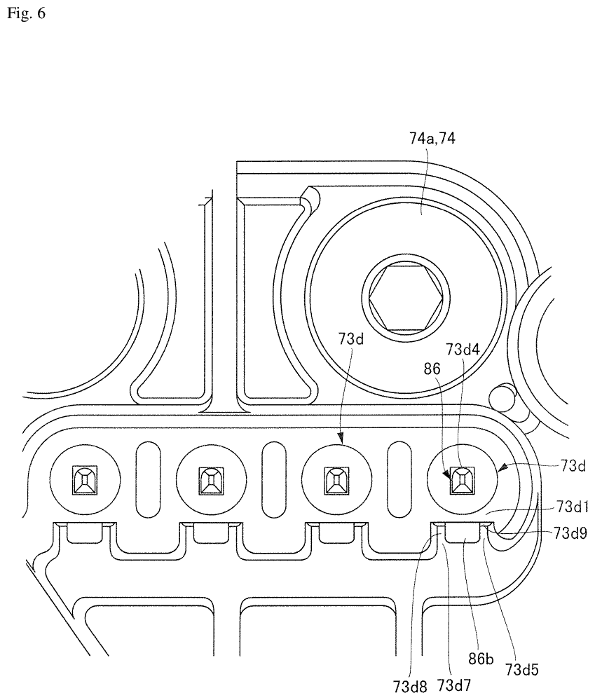

FIG. 4 is a partial cross-sectional view of the circuit board assembly 70 according to the first example embodiment. FIG. 5 is a perspective view of the inverter housing 73 having an external terminal receiving part 73d according to the first example embodiment. FIG. 6 is a plan view of the external terminal receiving part 73d according to the first example embodiment. As shown in FIG. 4, the inverter housing 73 has the external terminal receiving part 73d that protrudes from a bottom surface 73a1 of the circuit board accommodating part 73a toward the side of a connection hole part 75b of the circuit board 75. In the present example embodiment, the external terminal receiving part 73d is provided on the bottom surface 73a1 of the circuit board accommodating part 73a on a right side in the X-axis direction. The connection hole part 75b into which an external terminal 86 is inserted is provided in the circuit board 75 facing the end part of the rear side of the external terminal receiving part 73d. The connection hole part 75b penetrates the circuit board 75 in a thickness direction (axial direction) thereof.

The external terminal receiving part 73d has an external terminal fitting hole part 73d2 penetrating between a circuit board side (rear side) end part 73d1 of the external terminal receiving part 73d and a bottom part 73i of the inverter housing 73. The external terminal fitting hole part 73d2 has an insertion side opening part 73d3 that opens to the bottom part 73i of the inverter housing 73, and a projection side opening part 73d4 that opens to the circuit board side end part of the external terminal receiving part 73d. The projection side opening part 73d4 is disposed to face the connection hole part 75b of the circuit board 75.

The external terminal 86 is inserted into the external terminal fitting hole part 73d2 from the insertion side opening part 73d3 and is disposed in the external terminal fitting hole part 73d2 in a state in which a tip part of the external terminal 86 protrudes from the projection side opening part 73d4 and is inserted into the connection hole part 75b. The external terminal 86 has a terminal body part 86a that holds an end part of an external cable 87 and electrically connects a conductor extending from the end part. The terminal body part 86a has a rod-shaped end part 86a1 inserted into the connection hole part 75b on the rear side, a conductor connection part 86a2 which is connected to an end part of the rod-shaped end part 86a1 on the front side and extends to connect the conductor for the front side, and a lid body part 86a3 (for example, of rubber) which covers an end part of the external cable 87 and has elasticity.

The terminal body part 86a has a rectangular parallelepiped shape, and a stopper part 86b is provided on a right side surface of the terminal body part 86a in the X-axis direction. The stopper part 86b comes into contact with a stepped part 73d5 provided in the external terminal fitting hole part 73d2 and prevents detachment of the external terminal 86. Details of the stopper part 86b and the stepped part 73d5 will be described later.

The lid body part 86a3 has a cylindrical shape and has a through hole 86a4 penetrating an inside thereof in the axial direction. The external cable 87 passes through the through hole 86a4. A protrusion part 73d6 protruding inward in the radial direction is provided on an inner surface of the external terminal fitting hole part 73d2 into which the lid body part 86a3 is inserted. In the present example embodiment, the protrusion part 73d6 is provided on the front side of the inner surface of the external terminal fitting hole part 73d2. An outer surface of the lid body part 86a3 has a locking recess part 86a5 into which the protrusion part 73d6 is fitted. In the present example embodiment, a recess and protrude part having both a recessed part and a protruding part is provided on each of the inner surface of the external terminal fitting hole part 73d2 and the outer surface of the lid body part 86a3. With the lid body part 86a3 of the external terminal 86 inserted into the external terminal fitting hole part 73d2, the protrusion part 73d6 and the locking recess part 86a5 fit to each other, whereby the external terminal 86 is disposed in the external terminal fitting hole part 73d2.

The external terminal 86 has a stopper part 86b that is provided on a side surface of the external terminal 86 and extends obliquely outward in the radial direction as the external terminal 86 advances toward a side opposite to a position in which it is connected to the connection hole part 75b. In the present example embodiment, the stopper part 86b is provided on a right side surface of the terminal body part 86a in the X-axis direction. The stopper part 86b can be elastically deformed. For example, the stopper part 86b is made of a metal.

The stepped part 73d5 provided to protrude from the inner surface of the external terminal fitting hole part 73d2 has a cubic shape. In the present example embodiment, the stepped part 73d5 is provided at an intermediate position of the external terminal fitting hole part 73d2 in the axial direction. The stepped part 73d5 is configured such that, in a state in which the external terminal 86 is inserted in the external terminal fitting hole part 73d2, a distance X between the inner surface of the external terminal fitting hole part 73d2, which faces an inner tip part in the radial direction on the stepped part 73d5, and the tip part of the stepped part 73d5 is larger than a thickness W (a width in the X-axis direction) of the external terminal (terminal body part 86a), and a tip part of the stopper part 86b in the extending direction is disposed to face a surface 73d7 of the stepped part 73d5 on a side of the projection side opening part 73d4 (rear side). For this reason, when the external terminal 86 is inserted into the external terminal fitting hole part 73d2, the terminal body part 86a of the external terminal 86 can pass through the external terminal fitting hole part 73d2 on a side inward in the radial direction from the stepped part 73d5.

As shown in FIG. 5, the external terminal receiving part 73d has a cutout part 73d8 for communicating with the external terminal fitting hole part 73d2 on a side surface located on the side of the projection side opening part 73d4 from the stepped part 73d5. In the present example embodiment, the cutout part 73d8 has a rectangular shape when viewed from a plus side in the X-axis direction toward a minus side. A length of the cutout part 73d8 in the axial direction has a length from the surface 73d7 of the stepped part 73d5 on the rear side to the end part 73d1 of the external terminal receiving part 73d on the rear side. Also, a length of the cutout part 73d8 in the Y-axis direction has substantially the same length as a length of the stepped part 73d5 in the Y-axis direction. Further, when the external terminal receiving part 73d is viewed from the side of the projection side opening part 73d4 toward the insertion side opening part 73d3, that is, when the external terminal receiving part 73d is viewed from the rear side toward the front side thereof, as shown in FIG. 6, the stepped part 73d5 is disposed at a position in which the surface 73d7 of the stepped part 73d5 on the side of the projection side opening part 73d4 is exposed via the cutout part 73d8 and which does not overlap the end part 73d1 of the external terminal receiving part 73d on the side of the circuit board having the projection side opening part 73d4. That is, a gap 73d9 is provided between a left surface of the stepped part 73d5 in the X-axis direction and a right surface of the end part 73d1 in the X-axis direction.

When the external terminal 86 is inserted into the external terminal fitting hole part 73d2 from the insertion side opening part 73d3 of the external terminal receiving part 73d configured as described above, as shown in FIG. 4, the external terminal 86 is disposed in the external terminal fitting hole part 73d2 while the tip part of the external terminal 86 protrudes from the projection side opening part 73d4 and is inserted into the connection hole part 75b.

The circuit board 75 outputs motor output signals. As shown in FIG. 1, the circuit board 75 is disposed on the rear side of the circuit board accommodating part 73a and extends in a direction intersecting the axial direction. In the present example embodiment, the circuit board 75 extends in the X-axis direction orthogonal to the axial direction. A printed wiring (not shown) is provided on a surface of the circuit board 75 on the front side thereof (a front surface 75a). In addition, a plurality of electronic components are mounted on the front surface 75a of the circuit board 75. By using a copper inlay board as the circuit board 75, heat generated by a heating element (not shown) can be dissipated through the cover part.

As shown in FIG. 1, the inverter housing 73 has the base plate 77 on the front side. The base plate 77 is made of a metal and extends along the front side of a bottom surface 73e of the inverter housing 73. The base plate 77 has a shape similar to and larger than the front side of the bottom surface 73e of the inverter housing 73 and covers the bottom surface 73e.

The motor unit 10 having the shaft 11 centering on the central axis extending in a direction intersecting the base plate 77 is provided on a side (front side) opposite to a side of the inverter housing 73 with respect to the base plate 77. Also, the pump unit 40 that is driven by the motor unit 10 via the shaft 11 to discharge oil is provided on a side (front side) opposite to a side of the inverter housing 73 with respect to the motor unit 10.

The motor housing 13 has a bottomed cylindrical shape having the bottom part 13d on the circuit board assembly 70 side. In the motor housing 13, the inverter housing 73 is fixed to the bottom part 13d on the circuit board assembly 70 side via the base plate 77. In the present example embodiment, the base plate 77 is fixed to the bottom part 13d of the motor housing 13 by welding, and the bottom part 13d of the inverter housing 73 is fixed to the base plate 77 via fixing members 74 such as bolts 74a.

As shown in FIG. 4, the base plate 77 has a communication hole part 77d at a position facing the insertion side opening part 73d3 of the external terminal fitting hole part 73d2. An extension part 73d10 that extends toward one side in the axial direction on the base plate 77 through the communication hole part 77d is provided on the side of the insertion side opening part 73d3 of the external receiving part 73d. In the present example embodiment, the lid body part 86a3 described above is inserted into the extension part 73d10, and the front side of the lid body part 86a3 protrudes from the end part of the extension part 73d10 on the front side. For this reason, a distance between the external cable 87 and the bottom part 13d of the motor housing 13 can be further increased, thereby ensuring insulation of the external cable 87.

Also, as shown in FIGS. 4 and 5, the bottom part 73i of the inverter housing 73 has the metal fixing member 74 that fixes the bottom part 73i to the base plate 77, and the fixing member 74 is disposed adjacent to the external terminal receiving part 73d. In the present example embodiment, the metal bolt 74a is disposed adjacent to the external terminal receiving part 73d, and the bolt 74a passes through the bottom part 13d of the inverter housing 73 and is fastened to the base plate 77. For this reason, the inverter housing 73 can be firmly fixed to the base plate 77 via the bolt 74a.

In addition, a supporting part 77e that extends obliquely outward in the radial direction toward one side in the axial direction is provided at a side end part of the base plate 77 on a side in which the communication hole part 77d of the base plate 77 is provided. The supporting part 77e supports the external cable 87 that is electrically connected to the external terminal 86. For example, the external cable 87 extends along the supporting part 77e and is fixed to the supporting part 77e with a string, a binding band, or the like. Further, a hole part may be provided in the supporting part 77e, and the external cable 87 may be hooked in the hole part.

### <Pump Unit 40>

As shown in FIG. 1, the pump unit 40 is positioned on one side in the axial direction on the motor unit 10, specifically on the front side (−Z side). The pump unit 40 is driven by the motor unit 10 via the shaft 11. The pump unit 40 has a pump rotor 47 and a pump housing 51. The pump housing 51 has a pump body 52 and a pump cover 57. Hereinafter, each component will be described in detail.

### (Pump Body 52)

The pump body 52 is fixed in the front side (−Z side) of the motor housing 13 on the front side (−Z side) of the motor unit 10. The pump body 52 has a recessed part 54 that is recessed from the rear side (+Z side) of a surface thereof toward the front side (−Z side). A seal member 59 is accommodated in the recessed part 54. The pump body 52 has an accommodating part 53 that accommodates the pump rotor 47 and has a side surface and a bottom surface positioned on the rear side (+Z side) of the pump unit 40. The accommodating part 53 opens to the front side (−Z side) and is recessed toward the rear side (+Z side). A shape of the accommodating part 53 when viewed in the axial direction is a circular shape.

The pump cover 57 covers the pump body 52 from the front side (−Z side), thereby providing the accommodating part 53 between the pump cover 57 and the pump body 52. An annular recessed part 60 that is recessed inward in the radial direction is provided on an outer surface 52b on the rear side of the pump body 52. A seal member 61 (for example, an O-ring) is inserted into the recessed part 60.

The pump body 52 has a through hole 55 penetrating along the central axis J. The through hole 55 is configured such that both ends in the axial direction open to allow the shaft 11 to pass therethrough, an opening of the rear side (+Z side) opens in the recessed part 54, and an opening of the front side (−Z side) opens in the accommodating part 53. The through hole 55 functions as a slide bearing 45 that supports the shaft 11 rotatably.

Pump side flange parts 52a are provided at a radially outer end part of the pump body 52. A plurality of pump side flange parts 52a are provided at intervals in the circumferential direction.

### (Pump Cover 57)

As shown in FIG. 1, the pump cover 57 has a pump cover body part 57a attached to the front side of the pump body 52, and a pump cover arm part 57b extending from one end part in the radial direction on the pump cover body part 57a toward the motor unit 10 side.

Pump cover side flange parts 57a1 are provided at a radially outer end part of the pump cover body part 57a. A plurality of pump cover side flange parts 57a1 are provided at intervals in the circumferential direction. Female screws to which bolts 42a can be screwed are provided in the pump cover side flange parts 57a1.

The motor side flange parts 13c3 and the pump side flange parts 52a are disposed on the pump cover side flange parts 57a1 to overlap each other, and the bolts 42a that pass through the motor side flange parts 13c3 and the pump side flange parts 52a are fastened to the female screws provided in the pump cover side flange parts 57a1, whereby the motor unit 10 can be fixed to the pump unit 40.

The pump cover arm part 57b extends from the outer end part of the pump cover body part 57a on one side in the radial direction toward the rear side of the motor unit 10 along an outer surface 13e of the motor housing 13. The pump cover arm part 57b is formed in a rectangular parallelepiped shape to enhance rigidity. An end part of the rear side of the pump cover arm part 57b has a pump fixing part 65 to be fixed. In the present example embodiment, the pump fixing part 65 is fixed to a transmission, for example. The pump fixing part 65 has a box shape and has a fixing hole part 65a penetrating in the Y-axis direction. A fixing member such as a bolt is inserted into the fixing hole part 65a, and the pump fixing part 65 is firmly fixed to a fixture object such as a transmission.

In the present example embodiment, although an example in which the accommodating part 53 that accommodates the pump rotor 47 is provided in the pump body 52 has been shown, the present disclosure is not limited thereto. The accommodating part 53 may be provided in the pump cover 57.

### (Pump Rotor 47)

The pump rotor 47 is attached to the shaft 11. More specifically, the pump rotor 47 is attached to the front side (−Z side) of the shaft 11. The pump rotor 47 includes an inner rotor 47a attached to the shaft 11 and an outer rotor 47b surrounding a radially outer side of the inner rotor 47a. The inner rotor 47a has an annular shape. The inner rotor 47a is a gear having teeth on a radially outer surface thereof.

The inner rotor 47a is fixed to the shaft 11. More specifically, an end part of the front side (−Z side) of the shaft 11 is press-fitted inside the inner rotor 47a. The inner rotor 47a rotates around the axis (0 direction) together with the shaft 11. The outer rotor 47b has an annular shape surrounding the radially outer side of the inner rotor 47a. The outer rotor 47b is a gear having teeth on a radially inner surface thereof.

The inner rotor 47a and the outer rotor 47b engage with each other, and the outer rotor 47b rotates as the inner rotor 47a rotates. That is, rotation of the shaft 11 rotates the pump rotor 47. In other words, the motor unit 10 and the pump unit 40 have the same rotation axis. Thus, enlargement of the electric oil pump 1 in the axial direction can be inhibited.

Also, as the inner rotor 47a and the outer rotor 47b rotate, a volume between the engaged parts of the inner rotor 47a and the outer rotor 47b changes. A region in which the volume decreases is a pressurized region, and a region in which the volume increases is a negative pressure region. A suction port is disposed on the front side (−Z side) of the negative pressure region of the pump rotor 47. Also, a discharge port is disposed on the front side (−Z side) of the pressurized region Ap of the pump rotor 47. Here, oil sucked into the accommodating part 53 from an inlet 57c provided in the pump cover 57 is accommodated in the volume part between the inner rotor 47a and the outer rotor 47b and is sent to the pressurized region. Thereafter, the oil is discharged from an outlet 57d provided in the pump cover 57 through the discharge port.

### <Operations and Effects of Circuit Board Assembly 70 and Electric Oil Pump 1>

Next, operations and effects of the circuit board assembly and the electric oil pump 1 will be described. As shown in FIG. 1, when the motor unit 10 of the electric oil pump 1 is driven, the shaft 11 of the motor unit 10 rotates, and the outer rotor 47b rotates as the inner rotor 47a of the pump rotor 47 rotates. When the pump rotor 47 rotates, oil sucked from the inlet 57c of the pump unit 40 moves into the accommodating part 53 of the pump unit 40 and is discharged from the outlet 57d through the discharge port.

(1) Here, as shown in FIG. 4, the external terminal 86 of the circuit board assembly 70 according to the present example embodiment is inserted into the external terminal fitting hole part 73d2 from the insertion side opening part 73d3, and is disposed in the external terminal fitting hole part 73d2 in a state in which the tip part of the external terminal 86 protrudes from the projection side opening part 73d4 and is inserted into the connection hole part 75b. For this reason, the external terminal 86 and the circuit board 75 can be electrically connected by only inserting the external terminal 86 into the external terminal fitting hole part 73d2. Therefore, as compared with the case in which an external connector having the external terminal 86 and an internal connector electrically connected to the circuit board 75 are connected to each other, thereby electrically connecting the external terminal 86 to the circuit board 75, the number of components and the costs can be reduced, and miniaturization of the circuit board assembly 70 and the electric oil pump can be realized.

(2) Also, when the external terminal 86 is inserted into the external terminal fitting hole part 73d2, the protrusion part 73d6 and the locking recess part 86a5 fit together to dispose the external terminal 86 in the external terminal fitting hole part 73d2. For this reason, the external terminal 86 can be disposed in the external terminal fitting hole part 73d2 in a state in which the external terminal 86 is inserted into the external terminal fitting hole part 73d2.

(3) Also, the external terminal 86 has the elastically deformable stopper part 86b, and the stopper part 86b extends obliquely outward in the radial direction toward the side opposite to the location at which it is connected to the connection hole part 75b. For this reason, when the external terminal 86 is inserted into the external terminal fitting hole part 73d2, the stopper part 86b is elastically deformed and passes through the stepped part 73d5, whereby the external terminal 86 is connected to the circuit board 75. On the other hand, when the stopper part 86b passes through the stepped part 73d5, the stopper part 86b returns to its original state to be in a developed state, and the tip part of the stopper part 86b in the extending direction is disposed at the position facing the surface 73d7 of the stepped part 73d5 on the side of the projection side opening part 73d4. For this reason, a likelihood that the external terminal 86 will be pulled out from the external terminal fitting hole part 73d2 can be prevented.

(4) Also, the inverter housing 73 is an integrally molded product made of a resin, and when the external terminal receiving part 73d is viewed from the side of the projection side opening part 73d4 toward the insertion side opening part 73d3, the stepped part 73d5 is disposed at the position in which the surface 73d7 of the stepped part 73d5 on the side of the projection side opening part 73d4 is exposed via the cutout part 73d8 and which does not overlap the end part 73d1 of the external terminal receiving part 73d on the side of the circuit board 75 having the projection side opening part 73d4. For this reason, in the case in which a part of a metal mold used for integral molding is disposed around the stepped part 73d5, if the stepped part 73d5 is in a position overlapping the end part 73d1 of the external terminal receiving part 73d on the side of the circuit board 75, the part of the mold cannot be disposed around the stepped part 73d5, and the inverter housing 73 cannot be integrally molded with a resin. Therefore, the stepped part 73d5 is disposed at the position that does not overlap the end part 73d1 of the external terminal receiving part 73d on the side of the circuit board 75, so that the inverter housing 73 can be integrally molded with a resin.

(5) Also, the inverter housing 73 is fixed to the motor housing 13 of the motor unit 10 via the metal base plate 77. For this reason, when vibrations transmitted from the motor unit 10 or the like propagate to the inverter housing 73 via the base plate 77, an increase in vibration propagating to the inverter housing 73 can be inhibited. Further, since the external terminal 86 is disposed in the external terminal receiving part 73d provided in the inverter housing 73 to enable the inverter housing 73 to be downsized, the electric oil pump 1 having the inverter housing 73 can be reduced in size.

(6) Also, since the extension part 73d10 that extends to one side of the base plate 77 in the axial direction through the communication hole part 77d is provided with the side of the insertion side opening part 73d3 of the external terminal receiving part 73d, a possibility of the external cable 87 coming into contact with the metal base plate 77 can be prevented, and insulation of the external cable 87 can be maintained.

(7) The fixing member 74 is disposed adjacent to the external terminal receiving part 73d. In the case in which the metal fixing member 74 is disposed near the external terminal 86, if the distance between the external terminal 86 and the fixing member 74 is smaller than an insulation distance that can ensure insulation, insulation of the external terminal 86 cannot be ensured. However, since the external terminal receiving part 73d is made of a resin and the external terminal 86 is inserted into the external terminal receiving part 73d, the insulation of the external terminal 86 is maintained. For this reason, even if the fixing member 74 is disposed adjacent to the external terminal receiving part 73d, the insulation of the external terminal 86 can be ensured. Therefore, miniaturization of the inverter housing 73 can be facilitated.

(8) Also, the supporting part 77e is provided at the side end part of the base plate 77 on the side in which the communication hole part 77d is provided, and the supporting part 77e supports the external cable 87 that is electrically connected to the external terminal 86. For this reason, the external cable 87 extending from the external terminal 86 mounted in the external terminal fitting hole part 73d2 can be supported by the supporting part 77e.

Although exemplary example embodiments of the present disclosure have been described above, the present disclosure is not limited to these example embodiments, and various modifications and changes are possible within the scope of the gist of the present disclosure. These example embodiments and modifications thereof are included in the scope and gist of the present disclosure, and at the same time included in the disclosure described in the claims and the equivalents thereof.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-8. (canceled)

9. A circuit board assembly comprising:
a circuit board;
an inverter housing including a bottomed container-shaped circuit board accommodating portion that accommodates the circuit board; and
an external terminal located in the circuit board accommodating portion, connected to an end of the circuit board on one side in a width direction thereof, and extends to a bottom surface of the circuit board accommodating portion; wherein
the circuit board includes a connection hole into which the external terminal is inserted;
the connection hole penetrates the circuit board in a thickness direction thereof;
the inverter housing includes an external terminal receiving portion protruding from the bottom surface of the circuit board accommodating portion toward the side of the connection hole of the circuit board;
the external terminal receiving portion includes an external terminal fitting hole penetrating between an end of the external terminal receiving portion on the side of the circuit board and a bottom of the inverter housing;
the external terminal fitting hole includes an insertion side opening that opens at the bottom of the inverter housing, and a projection side opening that opens at the end of the external terminal receiving portion on the side of the circuit board;
the projection side opening faces the connection hole of the circuit board; and
the external terminal is inserted into the external terminal fitting hole from the insertion side opening and is disposed in the external terminal fitting hole in a state in which a tip of the external terminal protrudes from the projection side opening and is inserted into the connection hole.

10. The circuit board assembly according to claim 9, wherein
a protrusion protruding inward in a radial direction of the external terminal fitting hole is provided on an inner surface of the external terminal fitting hole;
the external terminal includes a locking recess that fits into the protrusion; and
in a state where the external terminal is inserted into the external terminal fitting hole, the protrusion and the locking recess fit to each other to dispose the external terminal in the external terminal fitting hole.

11. The circuit board assembly according to claim 9, wherein
an inner surface of the external terminal fitting hole includes a stepped portion protruding inward in a radial direction thereof;
the external terminal includes a stopper on a side surface of the external terminal and extending obliquely outward in the radial direction toward a side opposite to a location at which the external terminal is connected to the connection hole;
the stopper is elastically deformable; and
the stepped is configured such that, in a state in which the external terminal is inserted into the external terminal fitting hole, a distance between the inner surface of the external terminal fitting hole, which faces an inner tip of the stepped portion in the radial direction, and the tip of the stepped portion is larger than a thickness of the stepped portion of the external terminal in the protruding direction, and a tip of the stopper in the extending direction is disposed to face a surface of the stepped portion on a side of the projection side opening.

12. The circuit board assembly according to claim 11, wherein
the inverter housing is an integrally molded product made of a resin;
the external terminal receiving portion includes a cutout communicating with the external terminal fitting hole on a side wall thereof located on the side of the projection side opening from the stepped portion; and
when the external terminal receiving portion is viewed from the side of the projection side opening toward the insertion side opening, the stepped portion is disposed at a position in which the surface of the stepped portion on the side of the projection side opening is exposed via the cutout and which does not overlap the end of the external terminal receiving portion on the side of the circuit board side including the projection side opening.

13. An electric oil pump comprising:
the circuit board assembly according to claim 9;
a metal base plate on the bottom of the inverter housing and extending along a bottom surface of the bottom;
a motor including a shaft centering on a central axis extending in a direction intersecting the base plate, on a side opposite to the inverter housing side with respect to the base plate; and
a pump on one side in an axial direction thereof opposite to the inverter housing side with respect to the motor and is driven by the motor via the shaft to discharge oil; wherein
the motor includes a rotor fixed to the other side of the shaft in the axial direction, a stator positioned outward in the radial direction from the rotor, and a motor housing accommodating the rotor and the stator;
the pump includes a pump rotor attached to the shaft protruding to one side of the axial direction from the motor, and a pump housing including an accommodating portion which accommodates the pump rotor;
the motor housing includes a bottomed cylindrical shape including a bottom on the inverter housing side; and
the motor housing fixes the inverter housing to the bottom on the inverter housing side via the base plate.

14. The electric oil pump according to claim 13, wherein
the base plate includes a communication hole at a position facing the insertion side opening of the external terminal fitting hole; and
an extension that extends toward one side of the base plate in the axial direction through the communication hole is provided on the insertion side opening side of the external terminal receiving portion.

15. The electric oil pump according to claim 14, wherein
the inverter housing is made of a resin;
the bottom of the inverter housing includes a metal fixing member which fixes the bottom to the base plate; and
the fixing member is adjacent to the external terminal receiving portion.

16. The electric oil pump according to claim 15, wherein
a support extending obliquely outward in the radial direction toward one side in the axial direction is provided at a side end of the base plate on a side in which the communication hole of the base plate is provided; and
the support supports a cable electrically connected to the external terminal.
